(19) United States
(12) Patent Application Publication
(10) Pub. No.: US 2022/0268076 A1
(43) Pub. Date: Aug. 25, 2022

(54) ACCESS CONTROL DEVICE AND PEDESTRIAN GATE FOR SAME

(71) Applicant: Magnetic Autocontrol GmbH, Schopfheim (DE)

(72) Inventors: Timo RAUER, Rheinfelden (DE); Martin STEIERT, Wehr (DE)

(73) Assignee: Magnetic Autocontrol GmbH, Schopfheim (DE)

(21) Appl. No.: 17/628,288

(22) PCT Filed: Jun. 26, 2020
(86) PCT No.: PCT/EP2020/068149

§ 371 Date: Jan. 19, 2022

(30) Foreign Application Priority Data
Jul. 22, 2019 (DE) 20 2019 104 045.9

(51) Int. Cl. E05F 15/611; E01F 13/02; E06B 11/08

(52) U.S. Cl. CPC E05F 15/611; E01F 13/022; E06B 11/085; E05Y 2201/434; E05Y 2900/40

(57) ABSTRACT

A pedestrian gate (3) for an access control device, having a blocking element (7) and having an actuating element (8), wherein the blocking element (7) is fastened to the actuating element (8) and is pivotable via the actuating element (8) about a vertical axis of rotation (11) between a blocking position and an access position. The blocking element (7) is, in a vertical projection, formed so as to run substantially rectilinearly and, here, defines a vertical blocking plane (12) which does not include the axis of rotation (11).

### TECHNICAL FIELD

The present invention relates to a pedestrian gate for an access-control device and also to an access-control device having such a pedestrian gate.

### BACKGROUND

Accordingly, a pedestrian gate of the present type comprises a blocking element and an actuating element, wherein the blocking element is fitted on the actuating element and the actuating element can pivot the blocking element between a blocking position and an access position. The pedestrian gate here is one of which the blocking element can be pivoted about a vertical axis of rotation.

An access-control device of the present type contains at least one such pedestrian gate, which is arranged at the beginning, along the course and/or at the end of a corridor formed by right-hand and left-hand side boundaries. A pedestrian gate which is present in such an access-control device usually comprises a total of two blocking elements with a respectively associated actuating element, wherein the actuating elements are arranged, on both sides, on the side boundaries and, in their blocking position, the blocking elements each block only approximately half the width of the corridor. This reduces the bearing forces during the pivoting operation of the blocking element and minimizes the counter-torque which acts counter to the pivoting movement and increases on account of the leverage as the distance from the axis of rotation increases. This counter-torque results, in particular, from the air resistance. However, the lower moments of inertia in such a double-leaf pedestrian gate also have an advantageous impact. Nevertheless, the present invention also extends to pedestrian gates having just one pivotable blocking element.

Pedestrian gates and access-control devices of the present type can be found in a large number of fields of application in which specifically secured areas should be accessible to people, but this access has to be controlled. One function of the access-control device here is in separating the people who want to pass through the corridor of the access-control device into a protected or regulated area. This function is often paramount at concerts and sporting events and also at the point-of-sale terminals in supermarkets, but also when people are leaving particularly protected areas such as an airport-gate area. A further function of such an access-control device is important for protected areas which may be accessed only with specific authorization. Such specific authorization can be in the form of a ticket, a membership card, a passport or, in airports, a boarding pass; this can also involve the presence of biometric data, which can clearly identify a person who is authorized for access.

Such specific means of authorization are verified, at access-control devices of the present type, in particular by reader devices and, in dependence on the verification result, the pedestrian gate or the blocking element thereof is pivoted from the blocking position into the access position or else left in the blocking position. It is often the case, in particular for use in airports, that access-control devices of the present type are equipped with two successively arranged pedestrian gates—a first one in the entry region to the corridor and a second one at the end of the corridor—in order to form an access-control lock system. Such a lock system is also covered by the present invention. Access-control devices of this type are known, for example, from WO 2010/078856 A1.

In particular in the case of protected-area access-control devices through which a large number of people are to be directed in a controlled manner in the shortest possible period of time, as is the case in particular in airports, it has proven successful to arrange a plurality of access-control devices one beside the other, wherein the left-hand side boundary of the corridor of a first access-control device is, at the same time, the right-hand side boundary of the corridor of a second access-control device. Such joint usage of side boundaries optimizes the amount of space required for the access-control devices.

In this case, however, the units which are necessary for operating such an access-control device, for example a switch cabinet, a scanner and so on, likewise have to be arranged in the region of the side boundaries; these units are often integrated in the side boundary. If such a function-specific unit is located in the pivoting region of the blocking element of a pedestrian gate or access-control device of the present type, then either this blocking element cannot be pivoted all the way into the access position, i.e. at right angles to the blocking position, or the pedestrian-gate actuating element, on which the blocking element is fastened, has to be shifted further into the corridor, to allow the blocking element to be pivoted all the way into the access position.

On the one hand, this in turn has the disadvantage that people with trolley bags or with a wheelchair run the risk of getting stuck as they pass through the actuating elements. On the other hand, a minimum access width has to be maintained between an actuating element of a pedestrian gate and the opposite side boundary, or between two opposite actuating elements, and so the corridor, and therefore the width of the individual access-control devices, has to be wider or greater than this minimum width. In the case of a plurality of access-control devices arranged one beside the other, this can add up to such an extent that the number of access-control devices which can be installed is one fewer than is actually possible given the amount of space available.

Since, in particular in airports, the blocking elements increasingly have to meet requirements which stipulate that they should extend vertically up to a height of 1.60 m and above, the problems which have just been outlined also arise due to the handrails, usually provided on the side boundaries, for the people passing through the corridor, because such handrails are then inevitably located in the pivoting region of the blocking element or elements.

### SUMMARY

The present invention is based on the object of solving the problems outlined above and of proposing a pedestrian gate, but also an access-control device having such a pedestrian gate, which makes it possible to construct access-control devices of the present type with a smaller width than has been possible hitherto.

This object is achieved by a pedestrian gate having one or more of the features described herein and also by an access-control device having one or more of the features described herein. Preferred developments of the pedestrian gate according to the invention as well as configurations of the access-control device according to the invention are described below and in the claims.

According to the present invention, a pedestrian gate which comprises a blocking element and an actuating element, wherein the blocking element is fastened on the actuating element and, by means of the latter, can be pivoted, about a vertical axis of rotation, between a blocking position and an access position, is developed such that the blocking element runs essentially rectilinearly, as seen in a vertical projection, and, with this line on the horizontal projection surface, defines a vertical plane, which should be referred to here as a blocking plane. According to the invention, this blocking plane is spaced apart from the vertical axis of rotation, and therefore does not include the same. Since both the axis rotation and the blocking plane run vertically, a kind of parallelism is achieved. Within the context of the present invention, this need not be in a mathematical sense; rather, it is sufficient to have an approximate parallelism in which the axis of rotation and the blocking plane do not meet in the region of the pedestrian gate or of the access-control device.

This way of fitting the blocking element on the actuating element according to the invention makes it possible for the actuating element to be placed in very close vicinity of a side boundary of the corresponding access-control device even when operationally necessary or advantageous units designed for example in the form of function-specific modules, or a handrail of the access-control device, are located in the pivoting region of the blocking element. This is because, since the blocking plane is spaced apart from the axis of rotation, the blocking element can be fastened on the actuating element such that, in the access position, the blocking plane is spaced apart from the axis of rotation in the direction of the center of the corridor, and therefore the blocking element can be opened all the way, i.e. can be pivoted through approximately 90° in relation to the blocking position, without striking against a handrail and the like or a function-specific module projecting some way beyond the side boundary. Of course, the actuating element for its part need not project beyond the fully opened blocking element in the direction of the center of the corridor, but just needs to project to a lesser extent than has been the case hitherto so that the problems outlined in the introduction relating to a reduction in the access width, in particular in the case of actuating elements located opposite one another, are done away with.

Since it is made up of the two parts fastened on one another—the blocking element and actuating element—a pedestrian gate according to the invention can be assembled such that the pedestrian gate can be pivoted about the vertical axis of rotation optionally in either of the two directions of rotation, to achieve the advantages according to the invention.

As has been customary hitherto, the blocking element of the pedestrian gate according to the invention can be fastened on the actuating element along the vertical axis of rotation and, following a course which deviates in vertical projection, can then occupy the vertical blocking plane, which is spaced apart from the axis of rotation. However, the separation according to the invention of the vertical blocking plane from the vertical axis of rotation allows further advantages in particular when the blocking element is fastened eccentrically on the actuating element, as seen in relation to the axis of rotation. This is because it is then also the case that a drive for the actuating element, the drive expediently having a shaft which is arranged along the vertical axis of rotation, and the fastening of the blocking element are spaced apart from one another. It is thus possible, for example, for the fastening of the blocking element on the actuating element to be released without contact having to be made by the drive train with the shaft running along the vertical axis of rotation.

The blocking element of the pedestrian gate according to the invention is preferably in planar form, wherein it is designed, in particular, essentially in the form of a panel, which can be produced from transparent panel-form material. Such blocking elements are usually used in particular for access control of areas where security is important, such as in airports, since it is not possible for anyone to pass under them or over them. A panel-form blocking element can be fastened particularly easily on the actuating element if a planar fastening surface is provided there for fastening purposes.

The actuating element is preferably designed in the form of a vertically oriented column, and this column is advantageously made up of a fixed base part and a retaining part, which can be rotated in relation to the base part. The blocking element is fastened on the retaining part, whereas a drive device for pivoting the retaining part, and therefore also the blocking element, is accommodated in the base part, this providing particular advantages. As already mentioned above, such a drive device can comprise a shaft which runs along the vertical axis of rotation and on which the retaining part is seated, in which case the latter rotates along with the shaft. When the blocking element is fastened eccentrically on the retaining part, there is no need for the connection between the retaining part and the shaft of the drive device to be released if the blocking element is to be released in order to be replaced or fitted in a different orientation.

The pedestrian gate according to the invention makes it possible, as is desirable for security reasons, for the blocking element to run vertically essentially over at least the entire vertical extent of the actuating element, even if this means that rails, handrails or function-specific modules extend into the “normal” pivoting region of the blocking element. Of course, it is also possible for the blocking element to run well beyond the vertical extent of the actuating element, in particular in the upward direction.

The access-control device according to the invention contains the pedestrian gate according to the invention, possibly with the preferred developments, and also right-hand and left-hand side boundaries for forming a corridor, wherein at least one pedestrian gate according to the invention is arranged on at least one side boundary. For various reasons, it can be advantageous if, and it is usually the case that, the at least one pedestrian gate comprises two actuating elements which are arranged opposite one another and each bear a blocking element, wherein the blocking elements, in the blocking position, extend only into approximately the center of the corridor. This gives rise to an access gate with two pivoting-action leaves, this type of access gate being preferred on account of the advantageously small amount of surface area which is covered by the respective pivoting-action leaf as it pivots.

The access-control device according to the invention preferably has at least one function-specific module, which is arranged on a side boundary or, in particular, is also integrated in the same, this function-specific module, which can be, for example, a switch cabinet or a detection device for access authorization, is arranged in the pivoting region of the blocking element or, on account of the blocking plane being spaced apart according to the invention from the vertical axis of rotation, can be arranged there without having any effect on the pivoting region of the blocking element. This increases the flexibility of the arrangement of the individual modules or units of an access-control device and saves, in particular, valuable surface area which an access-control device requires not just over the width, but also over the length, of the corridor.

It is particularly advantageous if the or a pedestrian gate according to the invention is arranged at the beginning of the corridor of the access-control device. This is because, there, the actuating elements can be removed virtually completely from the corridor so that they do not disadvantageously decrease the width of the corridor, in particular if use is made of two actuating elements located opposite one another. The same effect is also achieved if the actuating elements of further pedestrian gates are integrated in the side boundaries of the access-control device.

### BRIEF DESCRIPTION OF THE DRAWINGS

An exemplary embodiment of an access-control device having a pedestrian gate configured according to the invention will be explained and described in more detail hereinbelow with reference to the attached drawings, in which:

FIG. 1 shows a plan view of an example of an access-control device configured according to the invention;

FIG. 2 shows a view from direction A according to FIG. 1;

FIG. 3 shows a side view taken along line B-B from FIG. 1; and

FIG. 4 shows an actuating element of a pedestrian gate configured according to the invention.

### DETAILED DESCRIPTION

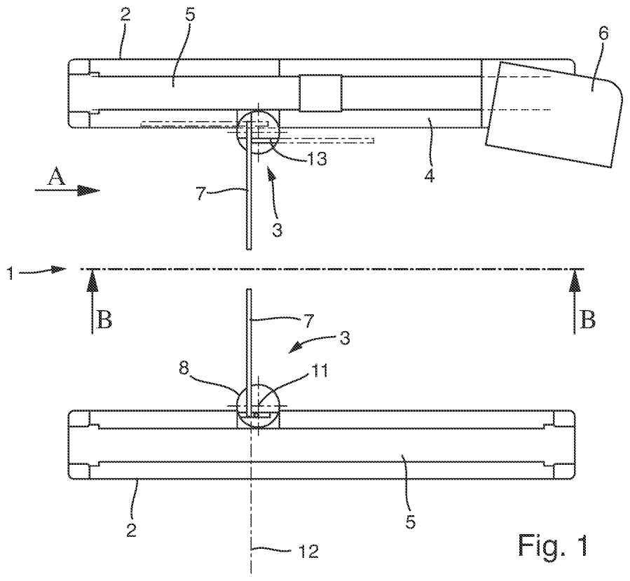

FIGS. 1, 2 and 3 illustrate three different views of the same example of an access-control device configured according to the invention. To the right and left of a corridor 1, which is accessed from the left-hand side in FIG. 1, are two side boundaries 2, between which the people for whom access is to be controlled are guided. A pedestrian gate 3, which at present is illustrated in the blocking position, blocks the corridor 1 and can free the same if appropriate. A reading unit (not illustrated), which is arranged in front of the corridor 1, verifies the access authorization, for example a boarding pass for boarding an aircraft, and, in the event of positive verification, generates a signal on the basis of which the pedestrian gate 3 is pivoted into an access position (the access position is indicated by dashed lines for the pedestrian gate 3 illustrated at the top of FIG. 1).

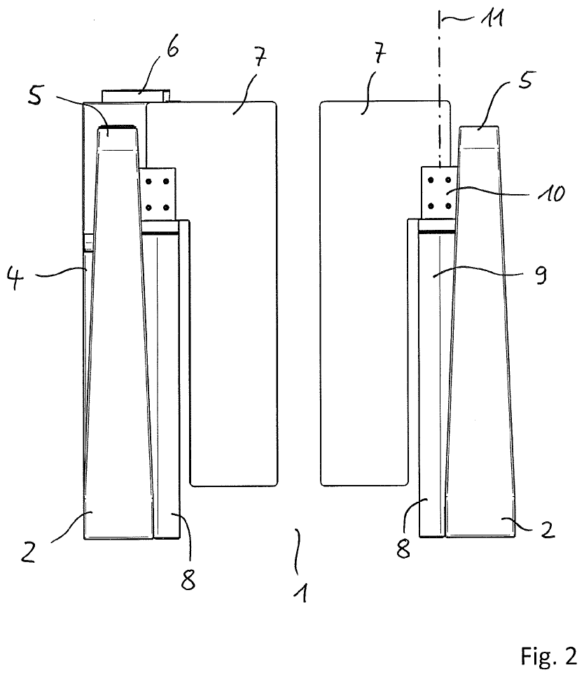

A function-specific module 4, in this case a switch cabinet, is integrated in the left-hand side boundary 2. This switch cabinet supplies both a drive (not illustrated) of the pedestrian gate and a detection module 6 with electrical energy, wherein the detection module 6 serves to detect biometric data, as is often collected on entry into an airport. A respective handrail 5 closes off the side boundaries 2 in the upward direction, this being best depicted in FIG. 2.

As can be seen to good effect with reference to FIGS. 1 and 2, the pedestrian gate 3 here comprises two sub-gates, which are arranged in a mirror-inverted manner and each comprise a column-like actuating element 8 and a panel-form blocking element 7. The actuating elements 8 are approximately half-integrated in the side boundaries 2 and therefore narrow the corridor 1 only to a minimal extent. In the blocking position, the blocking elements 7 extend only nearly to the center of the corridor 1, this ruling out a situation where the people for whom access is to be controlled, for example, trap a hand if the pedestrian gate 3 should close unexpectedly. For the same reason, a free space is provided as an anti-trap protection between the blocking elements 7 and the actuating elements 8, with the exception of the location at which the blocking element 7 is fastened on the actuating element 8.

As can be seen in FIGS. 1 and 2, the function-specific module 4, which is designed in the form of a switch cabinet, has its upper region projecting beyond the side boundary 2 in the direction of the corridor 1, and therefore, in the access position, a blocking element 7 fastened, as has been customary hitherto, along an axis of rotation 11 of the pedestrian gate 3 would possibly strike against the function-specific module 4; at least in that case the necessary distance of the standard 25 mm, in the present case 26 mm, would no longer be ensured to protect against fingers becoming trapped.

However, since a vertical blocking plane 12, which is defined by the blocking element 7, is spaced apart from the likewise vertically running access of rotation 11—in the present example, for this purpose, the blocking element 7 is fastened eccentrically on the actuating element 8—the blocking element 7, as indicated by dashed lines in FIG. 1, despite the actuating element 8 being largely integrated in the side boundary 2, maintains that distance from the function-specific module 4 which is prescribed to provide anti-trap protection, even when the blocking element has been pivoted into the access position (indicated by dashed lines).

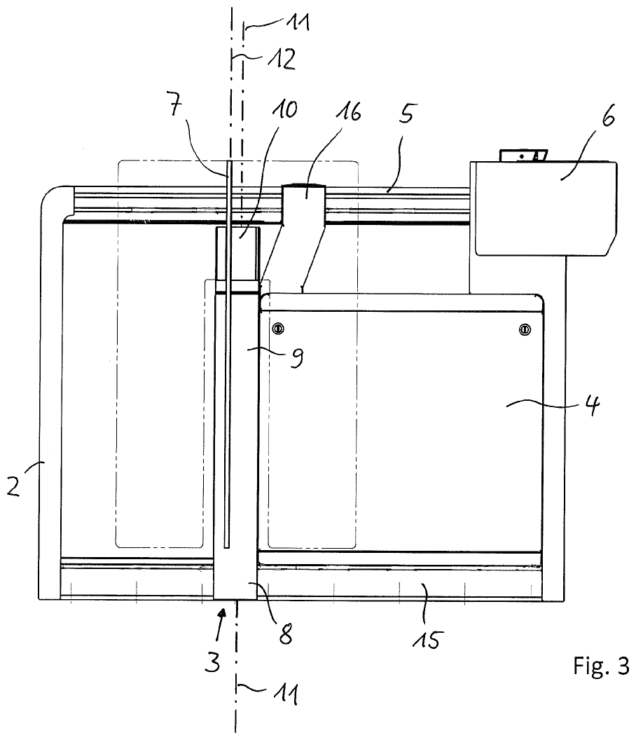

As FIG. 3 shows, the function-specific module 4 is seated on a rail 15 of the side boundary 2 and is connected, by means of a cable duct 16, to the handrail 5, in which for example signal lines can be guided. As is also indicated here by dashed lines, the blocking element 7 can be pivoted, about the axis of rotation 11, through approximately 90° in both directions starting from the blocking position.

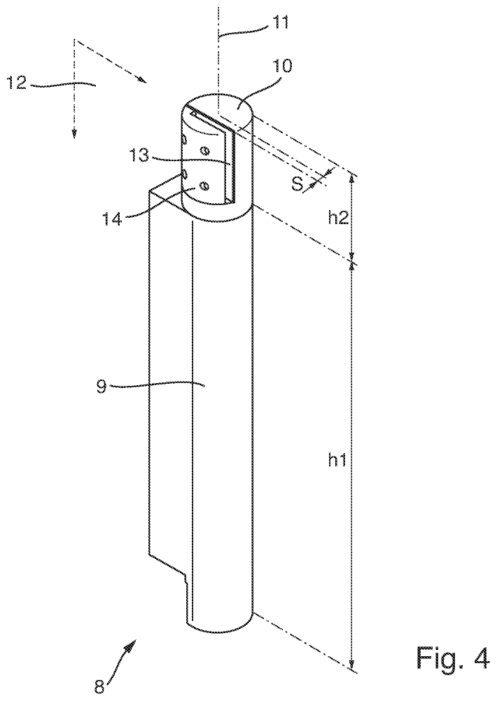

As can be seen with reference to FIG. 2, but primarily with reference to FIG. 4, the actuating element 8 comprises essentially two parts—a base part 9 and a retaining part 10. The base part 9 is fixed on the side boundaries 2, whereas the retaining part 10 can rotate, about the axis of rotation 11, on the base part 9. For this purpose, provision can be made for a drive device for rotating the retaining part 10 to be arranged in the interior of the base part 9 (not illustrated here). In an eccentric arrangement and/or spaced apart from the axis of rotation 11, the retaining part 10 has an installation surface 13, on which the panel-form blocking element 7 can be positioned and on which the blocking element 7 can be fastened by means of an installation cover 14. The blocking element can be used here in different orientations by the installation cover quite simply be rotated about a horizontal axis; it is therefore possible for structurally identical parts (base part 9, retaining part 10, installation cover 14 and blocking element 7) to be used to form both sides of the double-leaf pedestrian gate.

The blocking plane, which is defined by the installation surface 13 and/or by the rectilinear course of the blocking element 7, is indicated by dashed-line arrows. Both the blocking plane 12 and the access of rotation 11 are oriented vertically, that is to say they are located approximately parallel to one another, and are spaced apart from one another by a distance S.

The design of the actuating element 8 illustrated and the form of the blocking element 7 mean that the actuating element 8 can be designed predominantly (height h1) in a rigid manner, whereas the rotatable retaining part 10 extends only over a small height h2 and the extent of the moving parts is therefore minimized. This makes it possible not just to minimize the risk of accidents occurring, but also to keep the adjustment operation as well as the installation and removal of the blocking element 7 particularly simple.

As is immediately evident from the drawings, the actuating elements 8 of the pedestrian gate 8 can advantageously be integrated well within the side boundaries 2, wherein, in the access position, the blocking elements 7 are nevertheless spaced apart far enough from the side boundaries 2 and, in particular, from the function-specific module 4. This results in the corridor 1 having a sufficient width between the two actuating elements 8, without it being necessary for the side boundaries 2 to be shifted further apart for this reason. This saves valuable set-up space.

1. A pedestrian gate (3) for an access-control device, the pedestrian gate comprising:
a blocking element (7);
an actuating element (8), the blocking element (7) being fastened on the actuating element (8) such that the blocking element (7) is pivotable about a vertical axis of rotation (11), between a blocking position and an access position, via the actuation element (8); and
the blocking element (7) extends essentially rectilinearly, as seen in a vertical projection, and defines a vertical blocking plane (12), which does not include the vertical axis of rotation (11).

2. The pedestrian gate as claimed in claim 1, wherein the blocking element (7) is fastened eccentrically on the actuating element (8) with respect to the vertical axis of rotation (11).

3. The pedestrian gate as claimed in claim 1, wherein the blocking element (7) is planar in form.

4. The pedestrian gate as claimed in claim 3, wherein the blocking element (7) is configured as a panel made of transparent, virtually transparent or translucent material.

5. The pedestrian gate as claimed in claim 1, wherein the actuating element (8) is formed as a vertically oriented column and includes a fixed base part (9) and a retaining part (10), which is rotatable in relation to the fixed base part.

6. The pedestrian gate as claimed in claim 5, wherein the blocking element (7) is fastened on the retaining part (10) of the actuating element (8).

7. The pedestrian gate as claimed in claim 5, further comprising a drive configured to pivot the retaining part (10), and the blocking element (7) is accommodated in the base part (9).

8. The pedestrian gate as claimed in claim 5, wherein the retaining part (10) has an installation surface (13) for the blocking element (7), and the installation surface is spaced apart from the vertical axis of rotation (11).

9. The pedestrian gate as claimed in claim 4, wherein the actuating element (8) is formed as a vertically oriented column and includes a fixed base part (9) and a retaining part (10), which is rotatable in relation to the fixed base part, and the blocking element (7) runs vertically essentially over at least an entire vertical extent of the actuating element (8).

10. An access-control device, comprising a corridor (1), which is formed by right-hand and left-hand side boundaries (2), and at least one of the pedestrian gates (3) as claimed in claim 1, which is arranged on one of the side boundaries (2).

11. The access-control device as claimed in claim 10, wherein the at least one side boundary (2) is provided with a function-specific module (4) arranged in a pivoting region of the blocking element (7).

12. The access-control device as claimed in claim 10, wherein the pedestrian gate (3) is arranged at at least one of a beginning or an end of the corridor (1).

13. The access-control device as claimed in claim 10, wherein the pedestrian gate (3) is integrated in the side boundary (2).
